(19) United States
(12) Patent Application Publication
(10) Pub. No.: US 2020/0092379 A1
(43) Pub. Date: Mar. 19, 2020

(54) METHOD FOR ESTABLISHING A COMMUNICATION CONNECTION, VEHICLE COMMUNICATION DEVICE AND CHARGING STATION COMMUNICATION DEVICE

(71) Applicant: Robert Bosch GmbH, Stuttgart (DE)

(72) Inventors: Holger Leege, Leonberg (DE); Alexander Schanz, Muehlacker (DE); Michael Gerlach, Marbach A.N. (DE)

(21) Appl. No.: 16/495,124

(22) PCT Filed: Feb. 21, 2018
(86) PCT No.: PCT/EP2018/054250

§ 371 Date: Sep. 18, 2019

(30) Foreign Application Priority Data
Mar. 21, 2017 (DE) 10 2017 204 727.5

(51) Int. Cl. H04L 29/08; H04L 29/06; B60L 53/30; B60L 53/66

(52) U.S. Cl. CPC H04L 67/141; H04L 69/24; H02J 2007/0096; B60L 53/66; B60L 53/305

(57) ABSTRACT

The invention relates to the establishing of a communication connection between an electric or hybrid vehicle and a charging station. To this end, a transfer protocol, which enables communication between the electric or hybrid vehicle and the charging station, can be selected either in the electric or hybrid vehicle or alternatively in the charging station. Selection of a transfer protocol from a plurality of available transfer protocols enables a flexible coupling between the electric or hybrid vehicle and the charging station to be achieved.

### BACKGROUND OF THE INVENTION

The present invention relates to a method for setting up a communication connection between a vehicle communication apparatus and a charging station communication apparatus, to a vehicle communication apparatus, a charging station communication apparatus and a charging station having a charging station communication apparatus.

The document DE 10 2014 221 559 A1 discloses a method and a system for setting up a communication between a charging station and a vehicle. The communication connection between the vehicle and the charging station comprises a wireless communication connection between a vehicle communication unit of a vehicle and a charging station communication unit of a charging station.

Vehicles having an electric drive have an electrical energy store that can be used to store energy for operating an electrical drive of the vehicle. The battery of the vehicle can be charged with electrical energy, for example from an energy supply system. To this end, the battery is coupled to the energy supply system and electrical energy is transferred from the energy supply system to the battery of the vehicle. The coupling can be effected wirelessly or by wire between a charging station and the vehicle.

### SUMMARY OF THE INVENTION

The present invention discloses a method for setting up a communication connection between a vehicle communication apparatus and a charging station communication apparatus, a vehicle communication apparatus, a charging station communication apparatus and a charging station.

Accordingly, there is provision for:

A method for setting up a communication connection between a vehicle communication apparatus and a charging station communication apparatus. The method comprises the steps of coupling the vehicle communication apparatus to the charging station communication apparatus and identifying a common transmission protocol between the vehicle communication apparatus and the charging station communication apparatus. Further, the method comprises a step for setting up a communication connection between a vehicle communication apparatus and a charging station communication apparatus by using the identified common transmission protocol.

Further, there is provision for:

A vehicle communication apparatus having a first communication device and a first detector device. The first communication device is couplable to a charging station communication apparatus. The first detector device is designed to identify a common transmission protocol between the first communication device and a charging station communication apparatus coupled to the first communication device. Further, the first communication device is designed to set up a communication connection between the first communication device and the charging station communication apparatus coupled to the first communication device by using the identified common transmission protocol.

Furthermore, there is provision for:

A charging station communication apparatus having a second communication device and a second detector device. The second communication device is couplable to a vehicle communication apparatus. The second detector device is designed to identify a common transmission protocol between the second communication device and a vehicle communication apparatus coupled to the second communication device. The second communication device is designed to set up a communication connection between the second communication device and the vehicle communication apparatus coupled to the second communication device by using the identified common transmission protocol.

Finally, there is provision for:

A charging station having a charging station communication apparatus according to the invention.

The present invention is based on the insight that there currently exists numerous different transmission protocols for a communication between a vehicle and a charging station. Each of these transmission protocols uses a standard of its own for communication between the electric vehicle and the charging station in order to interchange the data required for charging the battery of the electric vehicle. It is therefore currently not possible to connect an electric vehicle to a charging station if the electric vehicle and the charging station use different transmission protocols.

It is therefore a concept of the present invention to take account of this insight and to provide for a flexible and as far as possible universal connection between the electric vehicle and the charging station that is not tied to a specific transmission protocol.

In this regard, it is a concept of the present invention to make provision in the vehicle and/or the charging station for a communication for multiple different transmission protocols and, when the electric vehicle is coupled to the charging station, to select a respective suitable transmission protocol that can be used by the vehicle and the charging station jointly. In this manner, an applicable electric vehicle can use different charging stations. In the same way, it is also possible to connect a charging station to multiple different electric vehicles and to allow relevant data to be interchanged.

The flexible adaptation of the charging station and/or electric vehicle when setting up the communication connection between the charging station and the electric vehicle allows electric vehicles and charging stations to be coupled to one another substantially more flexibly. As a result, the electric vehicles have a substantially closer-meshed network of charging stations available.

On top of this, a flexible selection of the transmission protocols for the communication between the electric vehicle and the charging station also allows for the development of both the charging systems and the charging station to be driven forward substantially more easily. When new developed standards and transmission protocols are made available beside already existing standards and transmission protocols in equal measure, it is always possible to ensure that older as well as more recent electric vehicles and charging stations can always be coupled to one another reliably.

According to one embodiment, the step for identifying the common transmission protocol involves a transmission protocol being selected from multiple predetermined transmission protocols. The prior stipulating of the available transmission protocols allows particularly easy and efficient adapting of the communication after the coupling of the vehicle and the charging station.

According to one embodiment, the predetermined transmission protocols comprise protocols based on the ISO/IEC 61851-23 and ISO/IEC 61851-24, CHAdeMO, Powerline (PLC), Combined Charging System (CCS), Tesla standard, WLAN and/or GB/T standard.

According to one embodiment, the step for coupling the vehicle communication apparatus to the charging station communication apparatus involves the vehicle communication apparatus being coupled to the charging station communication apparatus wirelessly or by wire. In particular for inductive charging, the communication between the vehicle and the charging station can also be carried out wirelessly. Accordingly, when the electric vehicle is charged by wire, the communication between the vehicle and the charging station can also be effected by wire. It is alternatively possible to carry out the data transmission wirelessly when the electric vehicle is charged by wire.

According to one embodiment of the vehicle communication apparatus, the first detector device is designed to identify the common transmission protocol by using a coded plug connection, a voltage potential and/or a transmitted data pattern. In this manner, the applicable coding allows a suitable transmission protocol to be determined very easily in each case.

According to one embodiment of the charging station, the second communication device is designed to set up a further communication connection to a further communication apparatus. In this case too, a respective suitable data transmission protocol can be selected that all the communication apparatuses involved understand. In this manner, it is for example possible to carry out a communication from the vehicle, if need be via the charging station, to further applications. By way of example, a communication can be effected from the vehicle via the charging station to a user terminal such as for example a cell phone, a tablet PC or further terminals.

According to one embodiment, the charging station is couplable to an energy supply system. In particular, the second communication device may be designed to set up a further communication connection to the energy supply system coupled to the charging station. In this manner, it is possible to transmit data from an electric vehicle via the charging station to the energy supply system and hence to further end points. By way of example, a communication can be effected between the operator of the energy supply system and the electric vehicle in order to match the charging process to the strain on the energy supply system. On top of this, it is also possible to use the energy supply system to set up a communication between the electric vehicle and further terminals.

The above configurations and developments can, insofar as expedient, be combined with one another arbitrarily. Further configurations, developments and implementations of the invention also include combinations, not explicitly mentioned, of features of the invention that are described above or below with regard to the exemplary embodiments. In particular, a person skilled in the art will in this case also add individual aspects as improvements or supplements to the respective basic form of the present invention.

### BRIEF DESCRIPTION OF THE DRAWINGS

The present invention is explained in more detail below on the basis of the exemplary embodiments indicated in the schematic figures of the drawings, in which:

FIG. 1: shows a schematic depiction of a communication between an electric vehicle and a charging station according to one embodiment;

FIG. 2: shows a schematic depiction of possible couplings between an electric vehicle and charging stations according to one embodiment;

FIG. 3: shows a schematic depiction of possible couplings between electric vehicles and a charging station according to one embodiment; and

FIG. 4: shows a schematic depiction of a flowchart, as forms the basis for a method for setting up a communication connection according to one embodiment.

### DETAILED DESCRIPTION

Throughout the figures, elements and apparatuses that are the same or have the same function are—unless indicated otherwise—provided with the same reference signs.

FIG. 1 shows a schematic depiction of a vehicle 1 at a charging station 2. The charging station 2 can be powered by an electrical energy source, for example an energy supply system 3. The charging of the energy store in the vehicle 1 can be effected for example via a wired connection between the charging station 2 and the vehicle 1. Alternatively, wireless energy transfer, for example by inductive coupling, between the charging station 2 and the vehicle 1 is also possible.

To initialize a charging process, which is supposed to involve an electrical energy store in the vehicle 1 being charged, and also possibly during the charging process, data can be interchanged between the vehicle 1 and the charging station 2. The data interchange in this case can be effected either by wire or wirelessly. In particular if the energy transfer between the charging station 2 and the vehicle 1 is effected wirelessly, a data interchange between the vehicle 1 and the charging station 2 in a wireless manner is also advantageous.

The data interchange between the vehicle 1 and the charging station 2 can comprise for example information about the state of charge of the energy store in the vehicle 1. On top of this, the data interchange can also comprise information about the configuration of the energy store in the vehicle 1, or further data relating to the vehicle 1 and in particular the energy store of the vehicle 1. Further, the data interchange can also comprise information about a legitimation, authentication, identification, data for billing and arbitrary further data. It is also possible to transmit, if need be, for example data about a desired state of charge needing to be achieved for the energy store in the vehicle 1 or a time for the completion of the charging process, and also further information relating to the charging process. On top of this, it is naturally also possible for arbitrary further data to be transmitted between the vehicle 1 and the charging station 2.

The data interchange between the vehicle 1 and the charging station 2 is normally effected on the basis of a prescribed data transmission protocol. To this end, this prescribed data transmission protocol needs to be implemented both in the vehicle communication apparatus 10 of the vehicle 1 and in the charging station communication apparatus 20 in the charging station 2. In this case, the data interchange between the vehicle 1 and the charging station 2 can be effected on the basis of a common data transmission protocol of this kind.

Such data transmission protocols are specified for example according to the ISO/IEC 61851-23 and ISO/IEC 61851-24, and also CHAdeMO, Combined Charging System (CCS), GB/T standard or the like. On top of that, regional standards for example in Asia, in particular China, or company-specific standards, for example from Tesla, are also possible for communication between the vehicle 1 and the charging station 2. On top of that, a communication according to the Powerline (PLC) standard or the like is also possible for a wired communication. Further, it is also possible for an arbitrary wireless standard, such as for example WLAN, Bluetooth, ZigBee, Z-Wave, GSM, UMTS, etc. to be used for a wired communication. Furthermore, arbitrary further proprietary solutions or new standards are also possible for a data communication between the vehicle 1 and the charging station 2.

At the beginning of the communication between the vehicle 1 and the charging station 2, it is necessary to ensure that the vehicle 1 and the charging station 2 agree on a common standard implemented by both participants. To this end, there may be provision in the vehicle communication apparatus 10 of the vehicle 1 for, besides a first communication device 11, a first detector device 12. This first detector device 12 can initially check, for example after the vehicle communication apparatus 10 in the vehicle 1 is coupled to the charging station communication apparatus 20 in the charging station 2, which data transmission protocol(s) are implemented in the charging station communication apparatus 20. Subsequently, the detector device 12 can select a data transmission protocol that is implemented both in the charging station communication apparatus 20 and in the vehicle communication apparatus 10. The first communication device 11 in the vehicle communication apparatus 10 of the vehicle 1 can then set up a communication connection to the second communication device 21 of the charging station communication apparatus 20 in the charging station 2 on the basis of the selected common data transmission protocol. In this manner, it is possible to ensure that a data transmission between the vehicle 1 and the charging station 2 is always performed on the basis of a suitable data transmission protocol that is implemented both in the vehicle communication apparatus 10 and in the charging station communication apparatus 20.

Alternatively, it is also possible for the selection of a suitable data transmission protocol to be made in the charging station 2. To this end, a suitable data transmission protocol implemented both in the vehicle communication apparatus 10 and in the charging station communication apparatus 20 can be selected in the charging station communication apparatus 20 of the charging station 2 by means of a second detector device 22 after the coupling of the charging station communication apparatus 20 to the vehicle communication apparatus 10.

The data transmission from and to the vehicle 1 does not have to be limited in this case to a data transmission between the vehicle 1 and the charging station 2. It is, besides, possible to extend the data transmission from and to the vehicle 1 to further communication apparatuses too. The data transmission can for example initially be effected between the vehicle 1 and the charging station 2, and, subsequently, data received by the charging station 2 can be transmitted to a further communication apparatus 30. In the same way, the charging station 2 can also receive data from a further communication apparatus 30 and forward them to the vehicle 1.

The further communication apparatus 30 may be for example a communication apparatus 30 in an energy supply system 3 connected to the charging station 2. In this manner, for example a network operator or else a further end point can set up a communication with the vehicle 1. By way of example, the network operator can therefore control the charging process for the energy store in the vehicle 1 in deliberate fashion and match it to the present conditions of the energy supply system 3.

On top of this, arbitrary further terminals can also carry out a data transmission with the vehicle communication apparatus 10 of the vehicle 1. By way of example, a user can use a smartphone, a tablet PC or an arbitrary other terminal to perform a communication with the communication apparatus 10 of the vehicle 1. In this manner, the user can for example monitor or control the charging process for the energy store in the vehicle 1. On top of this, it is also possible for further information to be interchanged between the vehicle 1 and the terminal of the user. In this case too, the first detector device 12 in the vehicle communication apparatus 10 can be used to initially identify and select a suitable data transmission protocol that allows a suitable data transmission between the vehicle communication apparatus 10 and the terminal of the user.

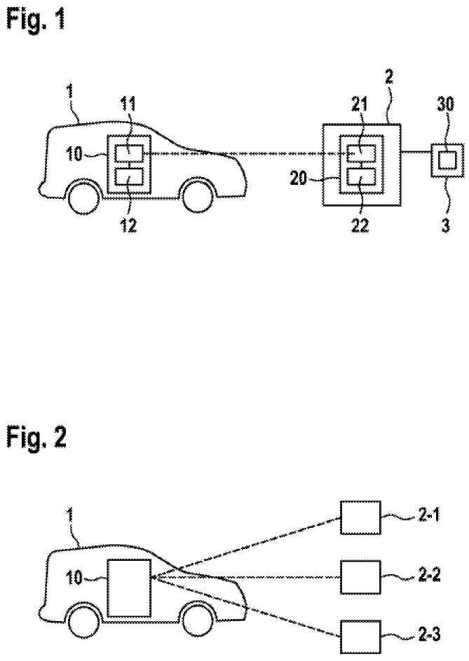

FIG. 2 shows a schematic depiction of the connection of multiple charging stations 2-i to a vehicle 1. In this case, for example the first charging station 2-1 may have a first data transmission protocol implemented in it, the second charging station 2-2 may have a second data transmission protocol implemented in it and the third charging station 2-3 may have a third data transmission protocol implemented in it. When the vehicle 1 is coupled to one of the three charging stations 2-i, it is possible in this case for a first detector device 12 in the first communication device 11 of the vehicle communication apparatus 10 to select the respective suitable data transmission protocol suitable for performing a data interchange with the coupled charging station 2-i. By way of example, respective suitable program blocks may to this end be stored in a memory in the vehicle communication apparatus 10. After the identification of the suitable data transmission protocol, it is then possible for the applicable program to be loaded from the memory so as then to carry out the data transmission using the suitable data transmission protocol.

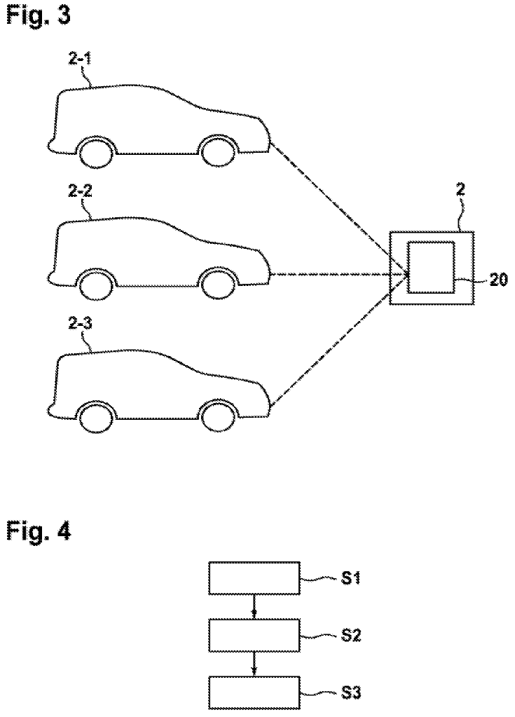

FIG. 3 shows a schematic depiction of a connection of multiple vehicles 1-i to a charging station 2. In this case, for example the first vehicle 1-1 may have a first data transmission protocol implemented in it, the second vehicle 1-2 may have a second data transmission protocol implemented in it and the third vehicle 3-3 may have a third data transmission protocol implemented in it. When one of the vehicles 1-i is coupled to the charging station 2, it is possible in this case for the second detector device 22 in the second communication device 21 of the charging station communication apparatus 20 to select the respective suitable data transmission protocol suitable for performing a data interchange with the coupled vehicle 1-i.

FIG. 4 shows a schematic depiction of a flowchart for a method for setting up a communication connection between a vehicle communication apparatus 10 and a charging station communication apparatus 20, according to one embodiment. In step S1, the vehicle communication apparatus 10 is coupled to the charging station communication apparatus 20. This coupling can be effected by wire or wirelessly, as already described previously.

In step S2, a common transmission protocol between the vehicle communication apparatus 10 and the charging station communication apparatus 20 is identified. This identification of the common transmission protocol can be effected by means of a coded connector or the like in the case of a wired coupling, for example. Further, the identification of the common transmission protocol can also be effected by analyzing a received data packet or the like. By way of example, identification of a data pattern in received data allows the respective transmission protocol to be identified. By way of example, the vehicle communication apparatus 10 or the charging station communication apparatus 20 can transmit a broadcast message received from the opposite party. This received broadcast message can then be evaluated in order to determine the data protocol used. Further, a suitable data protocol can also be provided on the basis of arbitrary further parameters, for example an applied voltage potential or the like.

After a common transmission protocol between the vehicle communication apparatus 10 and the charging station communication apparatus 20 has been identified, step S3 involves a communication connection being set up between the vehicle communication apparatus 10 and the charging station communication apparatus 20.

In summary, the present invention relates to the setup of a communication connection between an electric or hybrid vehicle and a charging station. To this end, it is possible, either in the electric or hybrid vehicle or alternatively in the charging station, for a respective transmission protocol to be selected that allows a communication between the electric or hybrid vehicle and the charging station. The selection of a transmission protocol from multiple available transmission protocols allows flexible coupling between the electric or hybrid vehicle and the charging station to be achieved.

1. A method for setting up a communication connection between a vehicle communication apparatus (10) and a charging station communication apparatus (20), having the steps of:
coupling (S1) the vehicle communication apparatus (10) to the charging station communication apparatus (20);
identifying (S2) a common transmission protocol between the vehicle communication apparatus (10) and the charging station communication apparatus (20); and
setting up (S3) a communication connection between the vehicle communication apparatus (10) and the charging station communication apparatus (20) by using the identified common transmission protocol.

2. The method as claimed in claim 1, wherein the identifying (S2) of the common transmission protocol selects a transmission protocol from multiple predetermined transmission protocols.

3. The method as claimed in claim 1, wherein the multiple predetermined transmission protocols comprise protocols based on the ISO/IEC 61851-23 and ISO/IEC 61851-24, CHAdeMO, Powerline (PLC), Combined Charging System (CCS), Tesla standard, WLAN and/or GB/T standard.

4. The method as claimed in claim 1, wherein the step for coupling the vehicle communication apparatus (10) to the charging station communication apparatus (20) couples the vehicle communication apparatus (10) to the charging station communication apparatus (20) wirelessly or by wire.

5. A vehicle communication apparatus (10) having:
a first communication device (11), which is couplable to a charging station communication apparatus (20); and
a first detector device (12), which is designed to identify a common transmission protocol between the first communication device (11) and a charging station communication apparatus (20) coupled to the first communication device (11),
wherein the first communication device (11) is designed to set up a communication connection between the first communication device (11) and the charging station communication apparatus (20) coupled to the first communication device (11) by using the identified common transmission protocol.

6. A vehicle communication apparatus (10), wherein the first detector device (12) is designed to identify the common transmission protocol by using a coded plug connection, a voltage potential and/or a transmitted data pattern.

7. A charging station communication apparatus (20) having:
a second communication device (21), which is couplable to a vehicle communication apparatus (10); and
a second detector device (22), which is designed to identify a common transmission protocol between the second communication device (21) and a vehicle communication apparatus (10) coupled to the second communication device (21),
wherein the second communication device (21) is designed to set up a communication connection between the second communication device (21) and the vehicle communication apparatus (10) coupled to the second communication device (21) by using the identified common transmission protocol.

8. A charging station (2) having a charging station communication apparatus (20) as claimed in claim 7.

9. The charging station (2) as claimed in claim 8, wherein the second communication device (21) is designed to set up a further communication connection to a further communication apparatus (30).

10. The charging station as claimed in claim 8, wherein the charging station (2) is couplable to an energy supply system (3), and the second communication device (21) is designed to set up a further communication connection to the energy supply system (3) coupled to the charging station (2).
